(19) United States
(12) Patent Application Publication
(10) Pub. No.: US 2026/0325386 A1
(43) Pub. Date: Oct. 22, 2026

(54) Biometric Adaptive Vibrotactile Apparatus

(71) Applicant: Simon Morris, New York, NY (US)

(72) Inventor: Simon Morris, New York, NY (US)

(73) Assignee: Simon Morris, New York, NY (US)

(21) Appl. No.: 19/396,867

(22) Filed: Nov. 21, 2025

Related U.S. Application Data
(60) Provisional application No. 63/725,882, filed on Jan. 27, 2025.

(51) Int. Cl. A61H 1/00; A61H 23/02

(52) U.S. Cl. CPC A61H 1/005; A61H 23/0236; A61H 2201/0142; A61H 2201/0161; A61H 2201/169; A61H 2201/5002; A61H 2201/5005; A61H 2201/5007; A61H 2201/5048; A61H 2230/425

(57) ABSTRACT

A biometric adaptive vibrotactile apparatus and method are disclosed for therapeutic, wellness, and nervous system regulation applications. The apparatus includes a foldable body with multiple segments, each containing tactile transducers that use direct electromagnetic actuation to impart controlled low-frequency vibrotactile energy without rotating imbalance. A processor performs spectral-synthesis digital signal processing, generating tactile waveforms from real-time biometric inputs such as heart rate, respiration, and electroencephalographic signals received through a biometric sensor interface. A microphone captures vocal and respiratory audio, and a machine-learning module generates control vectors to modulate waveform characteristics. A multi-channel digital-to-analog converter and solid-state routing subsystem enable independent multi-zone tactile stimulation. Waveform envelopes may synchronize with respiration phase, and inter-zone phase offsets may create traveling-wave patterns. The apparatus enables stress reduction, sleep enhancement, and autonomic regulation through closed-loop feedback that adapts tactile output to the user's physiological state in real time.

### CROSS-REFERENCE TO RELATED APPLICATIONS

This application claims the benefit of U.S. Provisional Patent Application No. 63/725,882, filed Jan. 27, 2025, titled “Portable Vibro-Acoustic Device for Enhanced Sleep, Recovery, and Nervous System Regulation.” The entirety of that application is incorporated herein by reference.

### FIELD OF THE INVENTION

The present disclosure relates to vibrotactile stimulation systems and biometric-responsive devices. More particularly, it pertains to foldable, multi-zone actuator arrays and digital signal processing techniques for generating adaptive tactile output based on real-time physiological and acoustic inputs.

### BACKGROUND

Vibrotactile and haptic feedback systems have become increasingly prevalent across a range of applications, from immersive virtual environments and gaming to therapeutic and relaxation contexts. These systems typically employ mechanical or electromechanical transducers—such as eccentric rotating mass motors, linear resonant actuators, or voice-coil exciters—to deliver tactile stimuli. In many cases, the goal is to evoke physiological or psychological responses by exposing the user to carefully controlled low-frequency vibrations. Despite the widespread adoption of haptic technologies, there remain few solutions that seamlessly integrate tactile feedback into everyday settings, ranging from personal wellness routines to clinical therapy and autonomic co-regulation contexts, where tactile stimulation supports modulation of the nervous system.

Across therapeutic and wellness domains, users seek tactile interfaces that support relaxation, stress reduction, and sleep enhancement without imposing complex setup requirements or intrusive hardware. Existing platforms often focus on delivering predetermined vibration patterns or simple oscillatory signals, relying on manual adjustment or static programming to achieve desired effects.

The full potential of vibrotactile stimulation—such as autonomic regulation, emotional modulation, and enhanced physical recovery—is realized only when tactile output is aligned with a user's dynamic physiological state. However, the ability to responsively adapt to moment-to-moment biometric changes is largely absent from current solutions.

A common approach in consumer haptic devices is direct audio mapping, where full-range or sub-bass audio signals are simply low-pass filtered and routed to a shaker. This results in several problems: the vibrational output mirrors the audio input or soundtrack, not an intentionally designed tactile pattern. Because these systems directly follow audio energy, dense mixes, transient peaks, clipped signals, or compression artifacts produce harsh, uneven, or fatiguing tactile output. The result is perceived not as a crafted tactile experience, but as a crude “bass boost” version of the soundtrack. This highlights the limitations of direct audio-to-vibration paradigms that do not employ dedicated DSP for tactile synthesis. Such systems fail to generate subtle, deep, smooth low-frequency signals tailored for recovery, sleep, and parasympathetic activation.

While a variety of sensors and wearable devices can monitor heart rate, respiration, HRV, motion or EEG brain-wave activity, current haptic solutions seldom leverage such inputs to adapt tactile output in real time. This disconnect forces users to rely on trial-and-error adjustments rather than benefiting from closed-loop feedback tailored to their autonomic condition.

Furthermore, single-zone vibration approaches lack the spatial resolution to target different body regions independently, limiting the ability to customize stimulus distribution for enhanced therapeutic or immersive effects. Even in systems that advertise “multi-channel” capability incorporating multiple actuators, the vibrational drive is typically derived from a two-channel stereo audio file, resulting in duplicated or mixed signals rather than independently synthesized tactile streams. As a result, no true spatial resolution or zone-specific control is achieved, and the tactile field remains fundamentally constrained by the structure of the audio program rather than by deliberate, multi-stream tactile design.

There remains a clear demand for a vibrotactile interface that bridges sensor data and actuator control in a cohesive, responsive manner, enabling dynamic, zone-specific modulation of tactile waveforms based on live physiological signals.

### SUMMARY

In one embodiment, the disclosure includes an apparatus for providing adaptive vibrotactile stimulation, comprising a foldable body with at least three segments; a plurality of tactile transducers distributed across those segments, each transducer using an electromagnetic actuation mechanism; a processor that performs spectral-synthesis digital signal processing by populating spectral-domain magnitude and phase representations and executing an inverse transformation; a biometric sensor interface to receive physiological data; a microphone to capture vocal and respiratory signals and extract vocal spectral features; a machine-learning module that generates a control vector specifying tactile waveform parameters; a multi-channel digital-to-analog converter subsystem; and a solid-state routing subsystem that delivers analog signals to at least three independently controllable zones.

The tactile transducers exclude eccentric rotating mass motors, offset-mass motors, and mechanically displaced mass vibration mechanisms. Waveform envelopes can be synchronized to respiration phase, and inter-zone phase offsets can produce traveling-wave patterns. Biometric inputs may include heart-rate variability, photoplethysmography, electrocardiography, respiration, electroencephalography, or wearable sensor signals. The routing subsystem can employ MOSFET arrays or analog cross-points and provide per-zone solid-state gain control.

In another embodiment, the disclosure includes a method for providing adaptive vibrotactile stimulation, comprising receiving biometric and acoustic data; extracting physiological and vocal spectral features; generating a control vector via a machine-learning module; performing spectral-domain waveform synthesis by populating magnitude and phase information and applying an inverse transform; routing the resulting analog signals through multiple channels; and modulating waveform envelopes to control vibrotactile actuation.

In a further embodiment, the disclosure includes a system for providing adaptive vibrotactile stimulation, comprising biometric sensors, an acoustic sensor, a spectral-analysis engine, a spectral-synthesis engine, a multi-zone transducer array, a multi-channel digital-to-analog converter subsystem, and a solid-state routing subsystem.

These and other features will be more fully understood from the following detailed description and accompanying claims.

### BRIEF DESCRIPTION OF THE DRAWINGS

FIG. 1 is a perspective view of an embodiment of the vibrotactile apparatus including the controller, support legs, and transducer array distributed across three foldable segments.

FIG. 2 illustrates an embodiment of the apparatus in a folded configuration, showing the foldable body, segment construction, and hinge arrangement.

FIG. 3 is an exploded view of an embodiment supported by a collapsible support frame with extendable bars, crossbars, support legs, and structural reinforcement features.

FIG. 4 illustrates an overview of user interaction with the apparatus, showing a user in a supine position producing vocal sound waves that are captured by a microphone and processed through vocal spectral analysis, a machine-learning inference engine, a control-vector generator, a digital signal-processing engine, and a multi-channel routing and zone-mapping subsystem to produce spatially distributed vibrational tactile output.

FIG. 5 illustrates a controller architecture block diagram showing the processor, sensor interfaces, DSP pipeline, ML control vector generation, and multi-zone routing used to drive vibrotactile outputs.

FIG. 6 is a block diagram of the machine-learning interface module, processor, DSP, and feature-extraction engines.

FIG. 7 illustrates a multi-channel digital-to-analog converter subsystem providing independent outputs to low-distortion Class-D amplifier stages that drive transducers through impedance-matched output filters.

### DETAILED DESCRIPTION OF THE INVENTION

The embodiments described herein relate to an adaptive vibrotactile apparatus, method, and system that generate low-frequency tactile waveforms responsive to biometric and acoustic inputs and distribute those waveforms across multiple independently controllable zones. While specific implementations and configurations are set forth to enable those skilled in the art to make and use the invention, the scope of the invention is defined by the appended claims, and various changes may be made without departing from that scope.

### Overview of Architecture

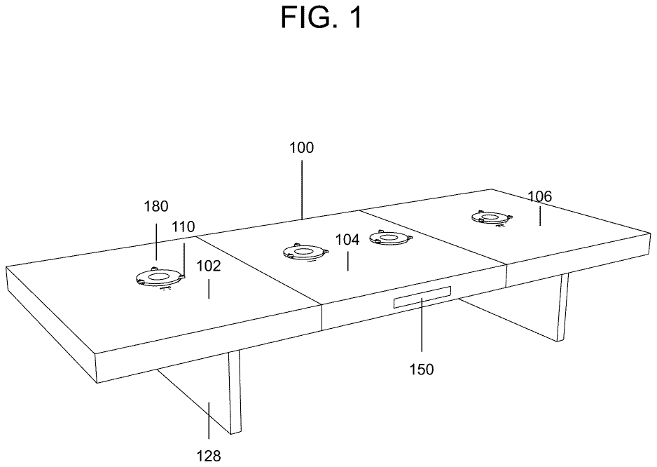

Referring to FIG. 1, in one embodiment, the apparatus includes a foldable body 100 having at least three segments 102, 104, and 106, which are configured to be deployed substantially coplanar during operation and folded for transport. Each segment houses one or more tactile transducers 180 that are coupled to a resonant surface or plate 110, enabling efficient transmission of vibrotactile energy to a user positioned on the apparatus.

A controller interface 150 is operatively coupled to the tactile transducers 180 and the resonant surface 110 and includes one or more computational and signal-generation subsystems. In the illustrated embodiment, the controller interface 150 comprises a processor configured to execute system-level control functions; a digital signal-processing (DSP) module configured to synthesize and modulate tactile waveforms; and a machine-learning (ML) module configured to generate a control vector responsive to biometric and acoustic features. The controller interface 150 further includes a biometric sensor interface which receives physiological signals from one or more biometric sensors including, for example, photoplethysmography (PPG), electrocardiography (EKG/ECG), respiration-phase sensors, electroencephalography (EEG), galvanic skin response (GSR), inertial motion sensors, posture sensors, and skin-temperature sensors.

The controller interface 150 also incorporates one or more audio front-end circuits configured to receive and digitize microphone signals used for vocal spectral analysis. The processor coordinates data acquisition, feature extraction, ML inference, and waveform synthesis, and communicates the resulting multi-channel tactile drive signals to a set of power amplifiers. The amplifiers are electrically coupled to the tactile transducers 180 and are configured to deliver zone-specific analog output levels, frequencies, and phases according to the waveform parameters generated by the DSP module and ML module.

Together, the foldable body 100, tactile transducers 180, resonant surface 110, and controller interface 150 form a unified vibrotactile stimulation system capable of generating adaptive, spatially distributed tactile outputs based on biometric and acoustic inputs. In some embodiments, the foldable body 100 is supported by a collapsible support.

### Foldable Body and Segment Construction

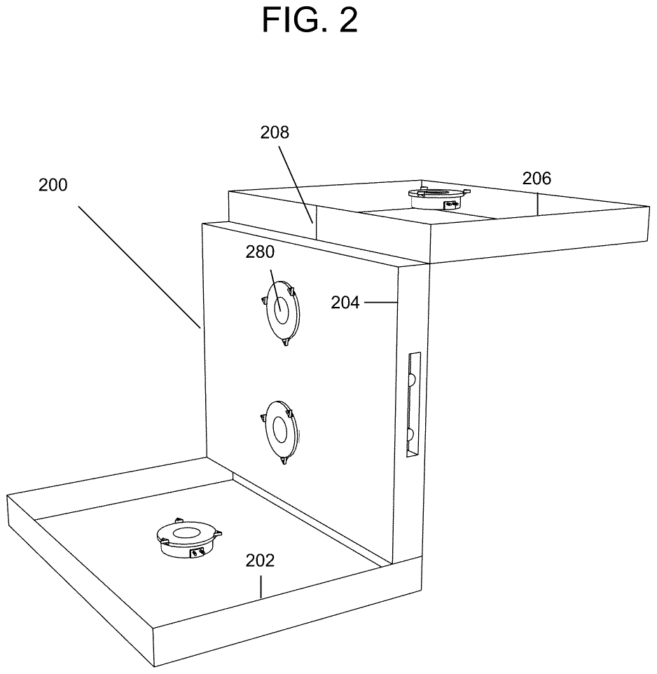

In FIG. 2, a foldable body 200 includes three segments 202, 204, 206 joined by flexible hinges 208 that maintain electrical continuity via flex printed circuits or multi-strand silicone-insulated conductors. In one configuration, segment dimensions range from 25 inches to 35 inches in length along the longitudinal axis, from 25 inches to 35 inches in width, and from 3 inches to 5 inches in thickness, with textile hinges 208 allowing a folding radius of 0 to 180 degrees.

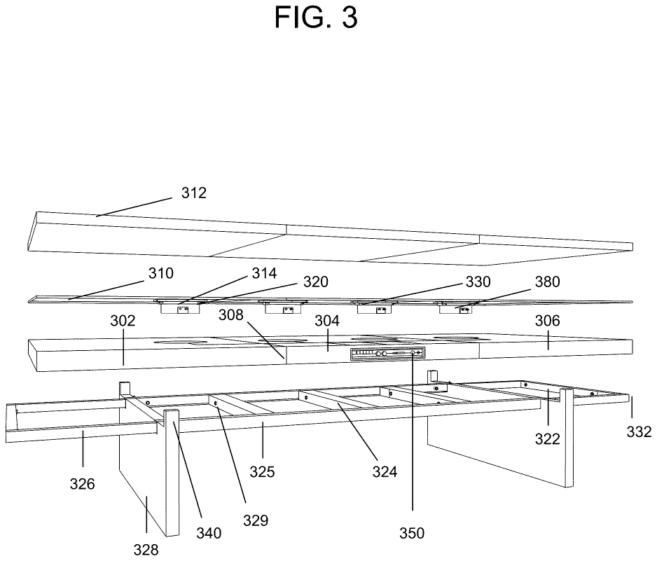

In certain embodiments, referring to FIG. 3, the foldable segments 302, 304, and 306 may be fabricated as lightweight composite panels formed by laminating a carbon-fiber top skin to a foam or honeycomb core and a fiber-reinforced polymer bottom skin using vacuum-assisted curing. Tactile transducers 380 are mechanically coupled to prepared mounting regions on the resonant surface 310 using fasteners selected to withstand long-term cyclical vibration, thermal variation, and repeated folding of the apparatus. Electrical wire harnesses are routed through the fold transitions and provided with strain-relief features at hinge locations 308, including serpentine slack or flexible PCB jumpers to accommodate repeated bending without conductor fatigue. Electronics, including the processor, digital-to-analog converter, amplifier subsystem, solid-state routing circuitry, and biometric and microphone interfaces, are housed within a shielded electronics compartment 350 incorporating electromagnetic-interference gaskets at cable egress points to maintain compliance with applicable regulatory emissions and immunity standards.

FIG. 3 further illustrates extendable bars 326 and wooden composite legs 328 that elevate the apparatus relative to a floor or underlying surface without providing any powered mechanical motion. The support 325 contains no motors, gears, or actuated elements, and it does not provide lifting, tilting, or motion-platform functionality. Instead, the support structure functions as an elevated platform that enhances portability and ergonomics. The support 325 can include alignment or indexing features 340 that mate with a controller enclosure and the segments 302, 304, 306 to ensure repeatable alignment of actuators 380 relative to anatomical landmarks, thereby improving the consistency of spatial patterns across sessions.

In one embodiment, the collapsible support 325 includes left and right-side rails 322 connected by one or more crossbars 324 that provide lateral stiffness and define the footprint of the elevated platform. Supports 326 attached to the side rails 322 or crossbars 324 elevate the frame and are extendable or telescopic to allow adjustment of overall height while remaining mechanically passive. Wooden or composite boards 328 may be placed across the crossbars 324 to form an elevated platform that supports the apparatus. Plastic end caps or plugs 322 can be used to cover exposed tube ends to reduce sharp edges and improve aesthetics. The support bar 326 may run along the longitudinal axis of the support to increase rigidity under load while preserving a lightweight, portable construction, and the frame components are configured to be assembled and disassembled using simple tension screws 329 for transport.

### Tactile Transducers and Resonant Coupling

As illustrated in FIG. 3, the tactile transducers 380 are electromagnetic actuators that impart vibrotactile energy without a mechanically oscillating unbalanced mass. Suitable devices include broadband electromagnetic exciters and voice-coil actuators configured to drive a coupling plate or resonant surface 310 that transfers vibrational energy into the foldable body 312.

In one embodiment, each segment 302, 304, 306 houses two to four exciters 380 screw mounted to a carbon fiber or composite wooden plate 310 of approximately 0.0125 inches to 0.25 inches thickness, tuned by plate geometry and boundary conditions to provide wideband transmission from approximately 1 Hz to 200 Hz. Compliant standoffs or gaskets 330 decouple the resonant surface 310 from the outer chassis while maximizing tactile energy transfer and minimizing airborne acoustic radiation. The transducers 380 explicitly exclude eccentric rotating mass motors, linear resonant actuators, offset-mass motors, and mechanically displaced-mass mechanisms that rely on rotation or a suspended mass for operation.

In some embodiments, actuator-plate assemblies are configured to deliver perceptible low-frequency tactile acceleration down to approximately 10 Hz, with reduced but detectable displacement achievable between 1 Hz and 10 Hz. Plate geometry, material stiffness, and compliant mounting boundaries are selected to maintain adequate transmissibility within this low-frequency band while staying within thermal and duty-cycle safety limits. These design parameters ensure that resonant or near-resonant mechanical behavior supports tactile output over the 1-200 Hz operating range described herein.

### Biometric and Acoustic Sensing and Feature Extraction

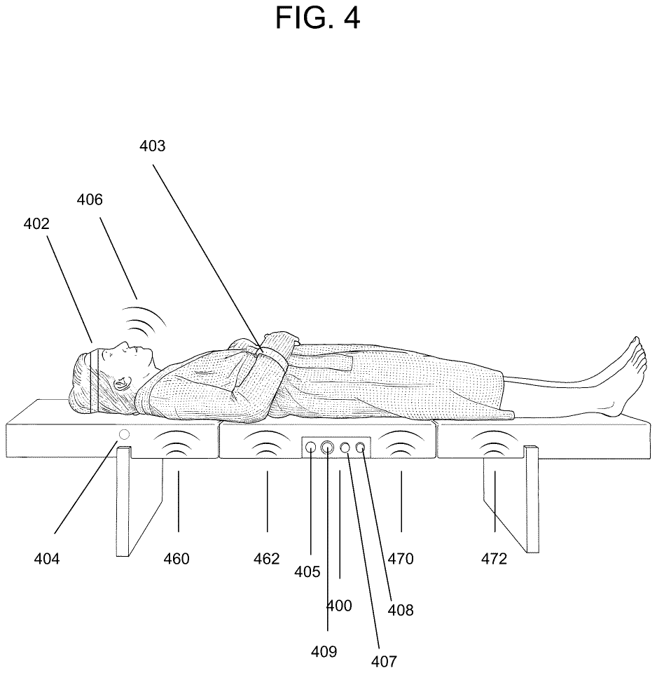

FIG. 4 illustrates an overview of user interaction with the apparatus. As shown in FIG. 4, a user lies in a supine position on the foldable vibrotactile apparatus 400, which includes a plurality of independently driven tactile zones 460, 462, 470, and 472. One or more biometric sensors 402, which may include photoplethysmography (PPG) sensors, electrocardiography (EKG/ECG) sensors, respiration sensors, electroencephalography (EEG) sensors, galvanic skin response (GSR) sensors, skin-temperature sensors, and a microphone, are positioned on or near the user or integrated into external third-party biometric devices. These sensors generate time-aligned physiological signals that characterize autonomic, cardiovascular, respiratory, vocal, neurological, and motion-related states.

In another embodiment, an external biometric device 403, such as a commercially available wearable including an Apple Watch®, Oura Ring®, WHOOP® band, chest-strap heart-rate monitor, or other third-party physiological sensing device, communicates biometric data to the controller of the apparatus. In the embodiment shown, external device 403 transmits physiological measurements—such as heart-rate variability, photoplethysmography waveforms, electrocardiography intervals, respiration phase, motion indices, or skin-temperature trends—via wireless communication protocols including Bluetooth®, BLE, Wi-Fi, or ANT+. The biometric sensor interface receives these data streams and fuses them with locally acquired sensor signals to generate synchronized machine-learning inputs and adaptive vibrotactile control parameters.

In another configuration, a microphone 404, positioned proximate to the user's head, captures sound waves 406 generated by vocalizations, humming, speech, chanting, toning, and respiratory airflow. The microphone provides a continuous acoustic input stream for vocal spectral and respiratory acoustics analysis.

Signals from the biometric sensors 402 and the microphone 404 are received by a multi-modal feature-extraction subsystem. Acoustic signals are processed by a vocal spectral-analysis engine 405, which computes vocal spectral features including fundamental frequency, pitch stability, spectral tilt, energy contour, formant trajectories, harmonic-to-noise ratio, mel-frequency cepstral coefficients, phonation onset/offset timing, and breath-related microacoustic events. Physiological features such as HRV metrics, R-R intervals, respiration cadence and phase, EEG band energies, GSR trends, motion indices, and skin-temperature variations are computed by a physiological feature-extraction engine 408.

These acoustic and physiological features are supplied to a machine-learning inference engine 407, which generates a multi-parameter control vector specifying tactile-waveform attributes including center frequency, harmonic composition, envelope shape, pulsation rate, respiration-phase alignment, inter-zone phase offsets, spatial pattern trajectory (including traveling-wave or bilateral patterns), and zone-specific gain values.

In certain embodiments, the controller maintains per-signal quality metrics, including signal-to-noise ratio (SNR), motion-artifact indices, contact-quality scores for PPG and ECG signals, and spectral confidence measures for vocal feature extraction. These metrics are used to weight, gate, or suppress unreliable features before they are supplied to the machine-learning inference module. When external third-party sensors (e.g., Apple Watch®, Oura Ring®, WHOOP®) introduce latency or packet loss, the system employs temporal alignment buffers to synchronize incoming physiological data with locally acquired signals.

### Respiration-Phase Synchronization

In certain embodiments, the controller derives a respiration-phase signal from chest belt sensors (part of biometric sensors 402), microphone-derived breath envelopes from sensor 404, or sensor fusion combining multiple inputs in modules 402 and 403. In one embodiment, a respiration sensor modulates the amplitude envelope produced by an envelope generator for one or more zones 460, 462, 470, and 472 such that the onset, peak, and decay portions align to inhalation and exhalation phases.

For example, the system may ramp amplitude by 1 dB to 3 dB during inhalation and reduce by a similar amount during exhalation, or apply a frequency glide on exhalation to encourage parasympathetic activation. Phase alignment error is estimated as the latency between detected phase crossings and envelope transitions and is maintained within ±300 ms by adaptive delay compensation and predictive filtering. If signal quality falls below a threshold determined from metrics, the system reverts to a fixed-cadence envelope derived from recent respiration history.

In a relaxation session, the controller 409 generates a base waveform consisting of a 40 Hz sinusoid with a slow 0.1 Hz amplitude modulation synchronized to exhalation peaks via a synchronizer, with traveling-wave phase offsets applied by a routing parameter generator and routing subsystem to draw tactile energy from the lower to the upper segments 472, 470, 462, and 460 during exhalation. If HRV increases and respiration slows, the controller gradually reduces center frequency to 30 Hz and increases envelope smoothness via the envelope generator.

In a recovery mode following exercise, the system emphasizes a broader spectral band centered around 60 Hz with intermittent 5 Hz to 10 Hz pulsations to promote perceived muscle relaxation, while ensuring acceleration and thermal parameters stay within predefined limits monitored by module 409.

In one embodiment, the controller maintains respiration-phase alignment of envelope onset and decay within approximately ±300 milliseconds. This is achieved using adaptive delay compensation, predictive filtering based on short-term respiration history, and compensation for microphone or sensor acquisition latencies. Alignment error is monitored continuously, and if deviation exceeds a threshold, the controller transitions to a fallback envelope derived from a smoothed respiration-template model.

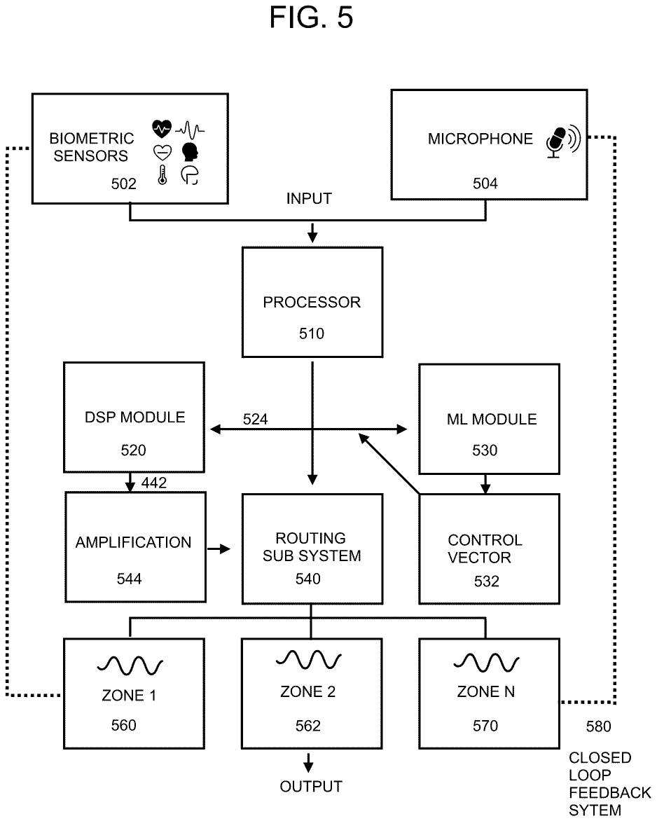

As shown schematically in FIG. 5, the apparatus further includes a controller comprising at least one processor 510, memory, a multi-channel digital-to-analog converter (DAC) subsystem 520, amplification stages 544, and a solid-state routing subsystem 540. A biometric sensor interface receives physiological data from local or external sensors 502, and a microphone 504 captures vocal and respiratory signals from the user. The controller executes a digital signal processing (DSP) pipeline that constructs vibrotactile waveforms by populating spectral-domain representations with magnitude and phase parameters and converting those representations to time-domain signals via an inverse transform. A machine-learning (ML) module 530 generates a control vector 532 that constrains waveform and spatial parameters, including amplitude envelopes synchronized to respiration phase and inter-zone phase offsets that synthesize traveling-wave patterns across zones 560, 562, 570.

The controller continuously receives updated biometric and acoustic features and uses them to adapt subsequent waveform synthesis, thereby forming a closed-loop feedback system 580 in which the vibrotactile output dynamically responds to changes in the user's physiological state.

The resulting vibrational tactile outputs are perceived by the user as spatially distributed, state-adaptive vibrotactile stimulation.

### Signal Generation and Spectral-Synthesis DSP

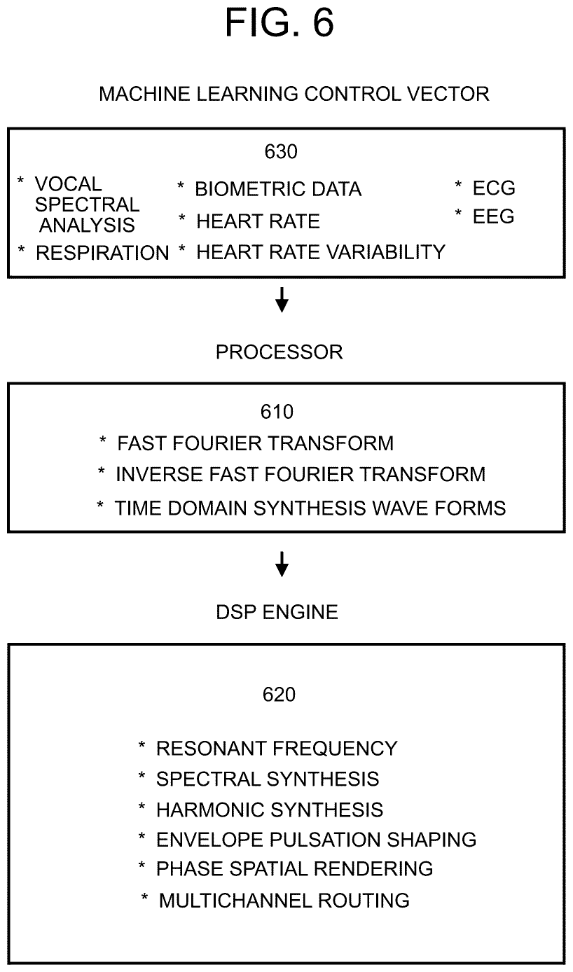

Referring to FIGS. 5-6, the processor generates tactile signals independent of audio program content by constructing spectral-domain arrays for each zone 560, 562, 570 and applying an inverse transformation 524. In one implementation, the processor 510 computes an inverse fast Fourier transform (IFFT) to synthesize time-domain waveforms from a complex spectral representation whose magnitudes and phases are populated based on the control vector 532. Window sizes for synthesis may be 128 ms to 2048 ms, with 50% to 75% overlap-add reconstruction for continuity. Sampling rates may range from 1 kHz to 48 kHz depending on actuator bandwidth and amplifier characteristics.

In alternative implementations, a discrete cosine transform, modified discrete cosine transform, or wavelet-based inverse transform is employed for improved control over spectral leakage at low frequencies. The DSP engine 520 can generate single-or multi-harmonic structures, band-limited noise with shaped spectral tilt, or narrowband sinusoids with slowly varying frequency and phase, constrained to a tactile band nominally between 1 Hz and 200 Hz. Dither and noise-shaping, together with dynamic range control, are applied to reduce quantization artifacts and maintain consistent perceived intensity.

In some embodiments, the apparatus maintains an end-to-end perception-to-actuation latency below 150 milliseconds. This latency budget includes physiological and acoustic signal acquisition (<30 ms), feature extraction and machine-learning inference (<20 ms), spectral-synthesis waveform generation (<50 ms), and routing, conversion, and amplifier drive (<50 ms). This ensures that tactile output remains perceptually synchronized with the user's physiological and vocal state.

Zone-specific equalization filters may be calibrated using a reference accelerometer positioned at each transducer location. Calibration signals are driven through each zone, and recorded acceleration is compared to a target magnitude response. Filter coefficients are then adjusted to achieve a per-zone magnitude response within approximately ±3 dB from 10 Hz to 150 Hz, ensuring consistent tactile intensity and spectral balance across zones.

### Machine-Learning Module and Control Vector

As indicated in FIG. 5-6, a machine-learning module 630 transforms features from modules 502 and 504 into the control vector 532 that parameterizes the DSP synthesis engine 520 and routing subsystem 540. In one embodiment, the machine-learning module 630 is trained on a dataset comprising supervised sessions collected across multiple participants spanning a range of ages and resting heart rates. Each session includes synchronized physiological features (e.g., HRV metrics, respiration cadence and phase, ECG-derived R-R intervals) and expert-specified tactile parameter trajectories with ground-truth outcomes, such as changes in short-term HRV (RMSSD) and respiration regularity indices. Data augmentation may include noise injection and temporal jitter within ±100 ms to increase robustness.

The resulting model is validated to achieve on-device inference latencies below 20 ms using 8-bit or 16-bit quantization, with control-vector stability assessed via confidence scores derived from feature quality metrics. In one embodiment, the module 530 is a lightweight recurrent neural network or temporal convolutional model trained on paired datasets of physiological features and expert-designed tactile parameter trajectories aimed at supporting relaxation and autonomic co-regulation. The control vector 532 includes parameters such as per-zone amplitude setpoints, time constants for attack and release segments of the envelope, center frequency, frequency deviation for slow modulation, harmonic composition, inter-zone phase offsets, nominal traveling-wave speed and direction, and respiration-phase alignment offsets. The module 530 may also output a confidence score used to adjust adaptation rate or to fall back to a safe baseline pattern. Over time, the machine-learning module 530 updates user-specific priors that bias parameter selection toward historically effective patterns, while preserving safety and comfort limits enforced by modules 520 and 532.

In all embodiments, the tactile waveforms synthesized by the DSP engine are generated independently of any music, soundtrack, or external audio program content. Microphone-derived acoustic signals are used solely for extraction of vocal and respiratory features and are not directly mapped to actuator drive signals. This ensures that tactile output is intentionally shaped according to physiological and ML-derived parameters rather than incidental audio content.

Following computation of the control vector by the machine-learning inference engine, a digital signal-processing (DSP) engine interprets these control parameters and generates the corresponding time-domain vibrotactile drive signals for each zone of the apparatus.

In FIG. 6, the DSP engine receives, as inputs, elements of the control vector including: (i) resonant target frequencies, (ii) harmonic ratios, (iii) pulsation rate and amplitude envelope definitions, (iv) inter-zone phase offsets, (v) spatial pattern descriptors (e.g., traveling-wave direction and velocity, bilateral symmetry, center-out propagation), and (vi) zone-specific gain coefficients.

Using the parameters supplied by the control vector, the DSP engine performs coordinated synthesis and modulation operations that together define the vibrotactile waveform presented at each zone. In one embodiment, the DSP engine generates sinusoidal or mixed-harmonic waveforms that are aligned to the resonant target frequency assigned to each transducer zone. Harmonic ratios may be applied to shape multi-component low-frequency structures that reflect physiological or acoustic patterns inferred from the user's biometric features.

The DSP engine further applies envelope shaping and pulsation control according to the attack, sustain, release, and modulation-rate characteristics specified by the control vector. Adjustable attack and release constants smooth transitions between waveform segments to avoid abrupt tactile artifacts. Spatial and phase-based rendering may also be performed, including the imposition of inter-zone phase differences that create coherent motion sensations across the body-contacting surface. In certain embodiments, the DSP engine generates spatial trajectories such as longitudinal or transverse traveling waves, bilateral alternation patterns, center-out or edge-in propagation, and circular or spiral trajectories that enhance immersion.

Zone amplitude is dynamically scaled according to gain coefficients provided by the control vector, and these amplitudes are further constrained by safety controls including acceleration limits, thermal monitoring thresholds, and duty-cycle protections that ensure safe operation under a wide range of conditions.

The resulting synthesized time-domain signals are then converted into discrete multi-channel digital audio streams or pulse-width-modulated signals appropriate for subsequent amplification and transducer actuation. Sample-accurate time-base management preserves phase coherence and maintains consistent timing alignment across all channels, ensuring that spatial patterns and inter-zone phase offsets are rendered with high fidelity.

The output of the DSP engine is therefore a fully synthesized, multi-zone vibrotactile waveform set, each channel shaped according to the user's combined biometric-acoustic state, as interpreted by the ML model. These signals drive the transducer array to produce personalized vibrotactile patterns intended to promote autonomic balance or address targeted neuromodulatory outcomes.

### Multi-Channel Conversion, Amplification, and Solid-State Routing

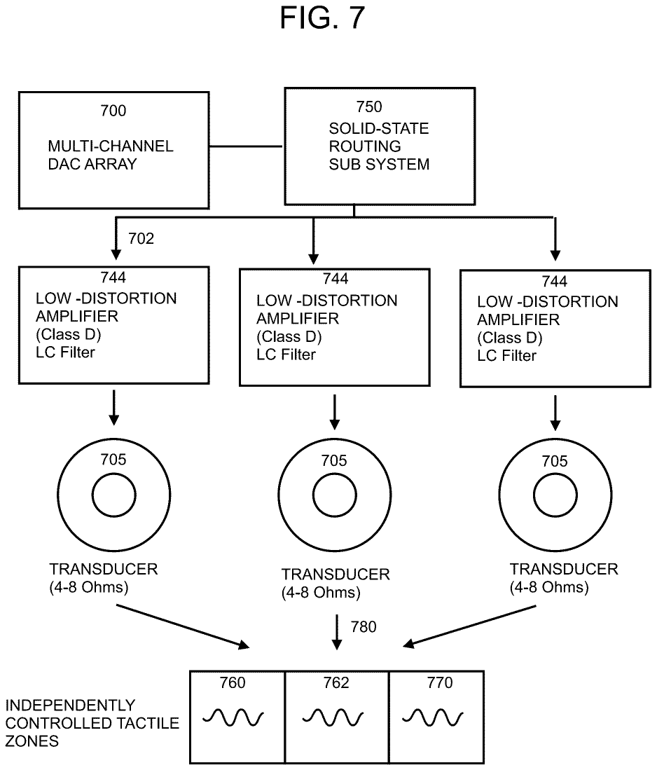

Referring to FIG. 7, the multi-channel digital-to-analog converter subsystem 700 provides at least three independent outputs 702 with 16-bit or 24-bit resolution and a dynamic range exceeding 90 dB. The outputs 702 feed low-distortion amplifiers 744, for example Class D amplifiers with switching frequencies above 300 kHz and output LC filters selected to the transducer impedance, which may be nominally 4 to 8 ohms per transducer 705.

The solid-state routing subsystem 750 comprises an analog switch matrix or MOSFET array configured to connect DAC outputs 702 to any zone or transducer grouping without the use of electromechanical relays. The solid-state routing subsystem 750 maintains inter-zone phase coherence by synchronizing switching events to waveform zero-crossings or to window boundaries of the synthesized waveform produced by engine 700, thereby avoiding audible artifacts or tactile discontinuities. Per-zone solid-state gain control is accomplished using digitally controlled potentiometers, voltage-controlled amplifier stages, or pulse-width modulation at a rate outside the tactile band followed by appropriate reconstruction filtering. A routing parameter generator 780 can compute phase offsets and panning parameters that are applied by subsystem 750 to zone outputs 760, 762, and 770.

As also illustrated in FIG. 7, inter-zone phase offsets are computed to synthesize traveling waves along the longitudinal axis of the apparatus. A desired apparent wave speed is achieved by phase incrementing at a rate tied to the synthesis window and the zone spacing. For example, a phase step of 45 degrees per 250 ms window across three zones 760, 762, and 770 produces a forward-propagating sensation with an apparent speed selectable between 0.1 m/s and 1.0 m/s depending on segment spacing.

Bidirectional and standing-wave patterns are generated by inverting or holding the phase offsets, or by superposition of counterpropagating components. Spatialization may also include amplitude panning and dynamic routing between overlapping transducer groups to create the perception of continuous motion across discrete zones 760, 762, and 770.

The apparatus may operate from an internal rechargeable lithium-ion battery pack or from an external DC supply managed by a power subsystem. Power management includes soft-start to avoid inrush current, battery protection with overcurrent and overtemperature cutoffs, and dynamic power scaling in which the controller reduces amplitude or duty cycle as available power decreases.

In some embodiments, inter-zone phase coherence is maintained within approximately ±10 degrees across the tactile frequency band of 1 Hz to 200 Hz. Sample-accurate time-base management ensures that each zone's synthesized waveform maintains consistent phase offset relative to others. When switching events occur within the solid-state routing subsystem, transitions are scheduled at waveform zero-crossings or at synthesis-window boundaries to minimize transient artifacts and preserve phase continuity.

In certain embodiments, compliant isolation mounts and decoupled chassis construction reduce airborne acoustic emissions. Measurements may be taken at a distance of 3 feet from the apparatus using A-weighted sound-pressure-level evaluation in a quiet-room environment. Under nominal operating conditions, airborne acoustic emissions can be maintained below approximately 35 dBA at three feet.

1. An apparatus for providing adaptive vibrotactile stimulation, comprising:
a foldable body comprising at least three segments, each segment having a resonant surface;
a plurality of tactile transducers disposed across the segments and mechanically coupled to the respective resonant surfaces;
a processor that executes stored instructions to perform spectral-synthesis digital signal processing by populating spectral-domain magnitude and phase representations and performing an inverse transform, the spectral-synthesis being independent of any external audio program content;
a biometric sensor interface configured to receive physiological data;
a microphone that captures vocal and respiratory audio;
a spectral-analysis engine that extracts vocal spectral features from the microphone signals for control-vector generation;
a machine-learning module that generates a control vector specifying tactile waveform parameters based on biometric and vocal features;
a multi-channel digital-to-analog converter subsystem; and
a solid-state routing subsystem that distributes analog signals to at least three independently controllable zones, wherein each zone corresponds to a segment or a defined grouping of one or more tactile transducers on a segment, and the subsystem applies programmable inter-zone phase offsets to produce traveling-wave tactile patterns.

2. The apparatus of claim 1, wherein the tactile transducers are selected from the group consisting of broadband electromagnetic exciters and voice-coil actuators and are not eccentric rotating-mass motors, linear resonant actuators, or mechanically displaced-mass mechanisms.

3. The apparatus of claim 1, wherein each resonant surface is driven within a tactile frequency band of 1 Hz to 200 Hz.

4. The apparatus of claim 1, wherein the resonant surface comprises a material selected from the group consisting of carbon fiber, wood, and composite laminate.

5. The apparatus of claim 1, wherein adjacent segments are joined by flexible hinges that include embedded electrical conductors.

6. The apparatus of claim 1, wherein the biometric sensor interface receives data from an external wearable device selected from the group consisting of a smart ring, a wrist-worn photoplethysmographic device, and an ECG device.

7. The apparatus of claim 1, wherein compliant isolation elements mechanically decouple the segments from surrounding structures to reduce airborne acoustic emissions during operation.

8. The apparatus of claim 1, wherein the multi-channel digital-to-analog converter subsystem provides at least three independent analog outputs having a resolution of 16 bits or 24 bits.

9. The apparatus of claim 1, further comprising Class-D amplifiers operatively coupled to the tactile transducers, the amplifiers being specified for transducers having a nominal impedance in the range of 4 ohms to 8 ohms.

10. The apparatus of claim 1, wherein the solid-state routing subsystem maintains inter-zone phase coherence during switching events by scheduling switching proximate to waveform zero-crossings while maintaining a common sample-accurate time base.

11. The apparatus of claim 1, wherein the processor aligns envelope onset and decay to detected respiration phase with an alignment error within ±300 milliseconds relative to the estimated inhalation and exhalation phases.

12. The apparatus of claim 1, wherein the inter-zone phase offsets generate traveling-wave tactile patterns having an apparent propagation velocity between 0.1 meters per second and 1.0 meters per second.

13. The apparatus of claim 1, wherein the machine-learning module performs on-device inference with a latency below 20 milliseconds measured from receipt of input features to output of the control vector.

14. A method for providing adaptive vibrotactile stimulation, comprising:
receiving biometric data and at least one of vocal audio and respiratory audio data;
extracting physiological features from the biometric data and vocal spectral features from the audio data using a physiological feature-extraction engine and a spectral-analysis engine;
generating, by a machine-learning model, a control vector specifying tactile waveform parameters based on the extracted features;
generating a tactile waveform by populating spectral-domain magnitude and phase representations and performing an inverse transform, independent of any external audio program content;
delivering zone-specific analog signals via a multi-channel digital-to-analog converter and a solid-state routing subsystem; and
modulating at least one of amplitude, phase, and spatial distribution based on changes in biometric features.

15. The method of claim 14, further comprising applying inter-zone phase offsets across independently controllable zones to generate traveling-wave tactile effects.

16. The method of claim 14, wherein envelope parameters are modulated according to detected respiration phase so that envelope onset and decay occur at defined phases of the respiratory cycle.

17. A system for providing adaptive vibrotactile stimulation, comprising:
one or more biometric sensors;
a microphone configured to capture vocal and respiratory audio;
a processor that executes instructions to extract vocal spectral features from the microphone signals and to synthesize tactile waveforms by spectral-domain population and inverse reconstruction, the synthesis being independent of external audio program content;
a physiological feature-extraction engine configured to extract physiological features from the one or more biometric sensors;
a multi-zone array of tactile transducers comprising electromagnetic exciters or voice-coil actuators that do not rely on rotating or mechanically displaced unbalanced masses;
a multi-channel digital-to-analog converter; and
a solid-state routing subsystem configured to distribute signals to at least three independently controllable zones and to maintain inter-zone phase coherence.

18. The system of claim 17, wherein the routing subsystem schedules switching events proximate to zero-crossings of the zone-specific analog signals.

19. The system of claim 17, wherein sensor-fusion weights are adaptively adjusted based on signal-quality metrics to stabilize control-vector generation when one or more signals are degraded or delayed.

20. The system of claim 17, wherein a spectral-analysis engine implemented by the processor is configured to extract vocal features including fundamental frequency, spectral tilt, formant trajectories, harmonic-to-noise ratio, and mel-frequency cepstral coefficients.
